(19) United States
(12) Patent Application Publication
(10) Pub. No.: US 2002/0173335 A1
(43) Pub. Date: Nov. 21, 2002

(54) Input system

(76) Inventor: Kam S. Liang, Hong Kong (CN)

Correspondence Address: DICKSTEIN SHAPIRO MORIN & OSHINSKY LLP, 2101 L STREET NW, WASHINGTON, DC, 20037-1526, US

(21) Appl. No.: 10/052,526

(22) Filed: Jan. 23, 2002

(30) Foreign Application Priority Data
May 18, 2001 (HK) 01103442.7

(51) Int. Cl. H04B 1/38

(52) U.S. Cl. 455/550; 455/90; 455/575

(57) ABSTRACT

An input system for an electronic device comprises a plurality of two digit numeric codes representing characters or character strings. The code for a character string comprises a combination of the first digits from its component characters. Information is input into the electronic device by pressing combinations of keys corresponding to two digit codes on an input interface.

### FIELD OF THE INVENTION

The invention relates to input systems, and in particular to a method of inputting characters and/or character strings into an electronic device or product such as a beeping pager, mobile phone, hand-held computer or the like.

### BACKGROUND TO THE INVENTION

Handheld devices such as beeping pagers, mobile phones, handheld computers and the like require some form of input means so that users can input information. The most common form of input means are small QWERTY keyboards, numeric keypads, and handwriting recognition pads. With these input means the input information must be directly input into the device.

The above-mentioned input means have a number of disadvantages including being difficult to use, particularly the small QWERTY keyboard, having a slow input speed and being difficult to use for long text inputting tasks.

### SUMMARY OF THE INVENTION

It is an object of the present invention to provide an input system that overcomes, or at least ameliorates, the above disadvantages, or at least to provide the public with a useful alternative.

According to a first aspect of the invention there is provided an input system for an electronic device comprising a plurality of two digit codes representing characters or character strings wherein information is input into the electronic device by pressing combinations of keys corresponding to two digit codes on an input interface.

Preferably, the codes donating the 26 letters in English are: A is 45; B is 86; C is 63; D is 08; E is 22; F is 53; G is 37; H is 13; I is 11; J. is 73; K is 01; L is 96; M is 53; N is 93; O is 00; P is 66; Q is 25; R is 43; S is 83; T is 76; U is 55; V is 56; W. is 65; X is 69; Y is 98; Z is 79.

In one embodiment the character strings are commonly used two letter combinations in the English language. In an alternative embodiment the character strings are letter combinations representing phonetic word sounds.

The system further comprises a plurality of two digit codes representing punctuation marks and special characters.

An input key may be provided to switch between input modes for different languages.

According to a second aspect of the invention there is provided an input system for an electronic device comprising a plurality of two digit numeric codes representing characters or character strings, wherein the code for a character string comprises a combination of the first digits from its component characters, and wherein information is input into the electronic device by pressing combinations of keys corresponding to two digit codes on an input interface.

According to a third aspect of the invention there is provided an input system for an electronic device comprising:

a numeric keypad, and

a plurality of two digit numeric codes representing characters or character strings wherein the code for a character string comprises a combination of the first digits from its component characters,

information being input into the electronic device by pressing combinations of numeric keys corresponding to two digit codes.

According to a forth aspect of the invention there is provided an input system for an electronic device comprising:

a numeric keypad including a plurality of number keys, and a plurality of two digit numeric codes representing characters or character strings, the number key corresponding to the first digit in a two digit code for a character having printed thereon an identifier of the second digit in the code, and wherein the code for a character string comprises a combination of the first digits from its component characters.

Further aspects of the invention will become apparent from the following description, which is given by way of example only.

### BRIEF DESCRIPTION OF THE DRAWINGS

Embodiments of the invention will now be described by way of example only and with reference to the accompanying drawings in which:

FIG. 1 illustrates an input keypad suitable for use with an input system according to the invention,

FIG. 2 illustrates code selection for an English version of an input system according to the invention,

FIG. 3 illustrates code selection for a Chinese version of an input system according to the invention,

FIG. 4 illustrates code selection for a Japanese version of an input system according to the invention,

FIG. 5 illustrates punctuation code selection for an input system according to the invention.

### DESCRIPTION OF THE PREFERRED EMBODIMENTS

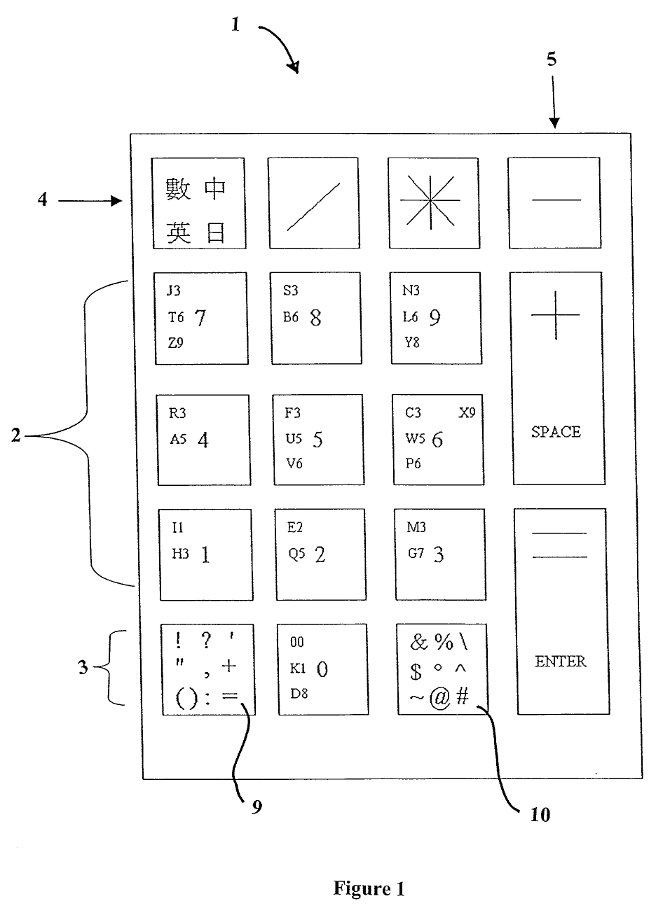

FIG. 1 illustrates an input keypad 1 for use with an input system according to the invention. In the center region 2 of the keypad 1 are keys for the numbers one through nine arranged in a known 3×3 pattern. In a region 3 directly below the number keys is a zero (0) key with a special character input key 9, 10 either side. Along the top row 4 and right-hand side column 5 of the keypad 1 are other function keys.

All examples of the input system given below can be implemented using the input keypad 1 illustrated in FIG. 1. However, this type of keypad is not essential to the invention and it will become apparent to the skilled addressee that other arrangements are possible. An alternative embodiment of the keypad is a simulation on a touch screen. Furthermore, the keypad shown is used for a combination English and Chinese language input system. However, the language used is not critical to the invention and may vary.

The invention provides for a plurality of two digit codes representing characters and/or character strings in a given language. Each character, for example each letter in the Roman alphabet, has a unique two digit code. Character strings are made up of the first digit of the letter (character) component parts of the string.

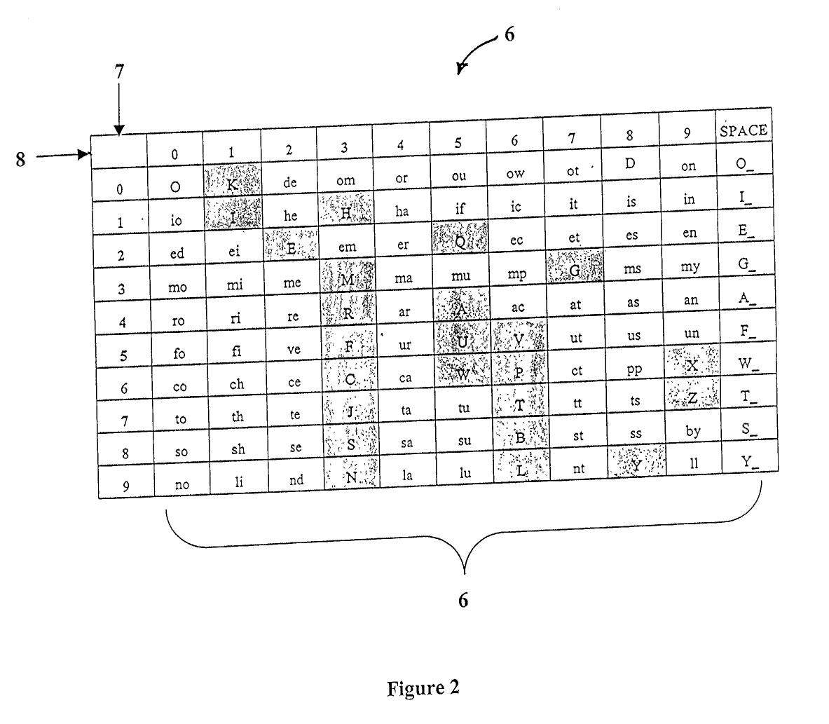

FIG. 2 illustrates how the codes are derived for the English language. The main body of a table 6 contains the characters and character strings. Individual letters (characters) are shown in shaded table 6 cells and letter combinations (character strings) are shown in non-shaded table 6 cells. In the unique intelligent code each letter and letter combination is derived from the first column 7 and the first row 8 of the table 6.

Codes are derived as follows, taking the letter “s” as an example. Letter “s” is located in the row designated eight in column 7 and the column designated three in row 8 of the table.

This is referred to as cell “83” of table 6. The digit 8 denotes the first digit of the Intelligent Code for letter “s” and the digit 3 denotes the second digit of the Intelligent Code. By way of a second example, the Intelligent Code for letter “Y” is 98 because letter “Y” is located in cell “98” that is the intersection of the row labelled “9” and the column labelled “8” in table 6.

Recognition of the first digit in the basic intelligent code for a single character is crucial for upgrading inputting speed. This is because the intelligent codes for letter combinations (character strings) are deduced by extracting and combining the first digits of the codes of each of the two different letters that make up the combination. Take the character string “SO” as an example. The Intelligent Code of the single letter “S” is “83” and the Intelligent Code of the single letter “O” is “00”. The Intelligent Code of the character string “SO” is therefore “80”. The first digit “8” comes from the first digit of the Intelligent Code of letter “S” and the second digit “0” comes from the first digit of the Intelligent Code of the letter “O”. The letter combination “SO” is located in the cell at the intersection of the row labelled “8” and the column labelled “0” in table 6. By using this first digit plus first digit method, the user can deduce the intelligent code for all character strings in table 6 and thus increase input speed for common letter combinations.

To save the user from the trouble of memorising the Intelligent Codes of the 26 letters of the alphabet the values of these Intelligent Codes are marked on the keypad as shown in FIG. 1. Take letter “A” as an example. The first value of the Intelligent Code of letter “A” is “4”, and the second value is “5”. On the button “4”, two extra signs A5 and R3 are printed. The letter “A” represents that button “4” is the first value or first key of the Intelligent Code of the letter “A” and the adjacent digit “5” tells the user the second value or the second key of the Intelligent Code of the letter “A” is the button “5”. Similarly, a sign R3 printed on button “4” tells the user that the first key for letter “R” is button “4” and the second key is button “3”.

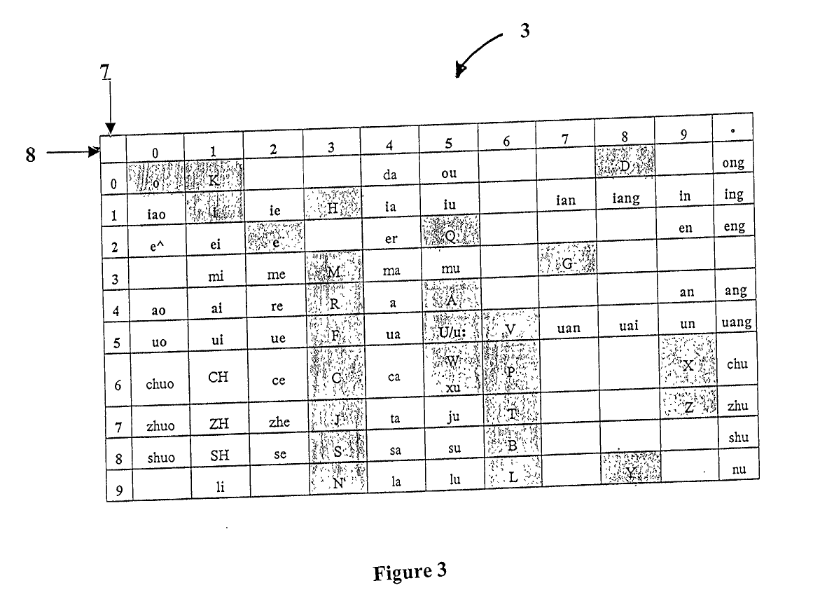

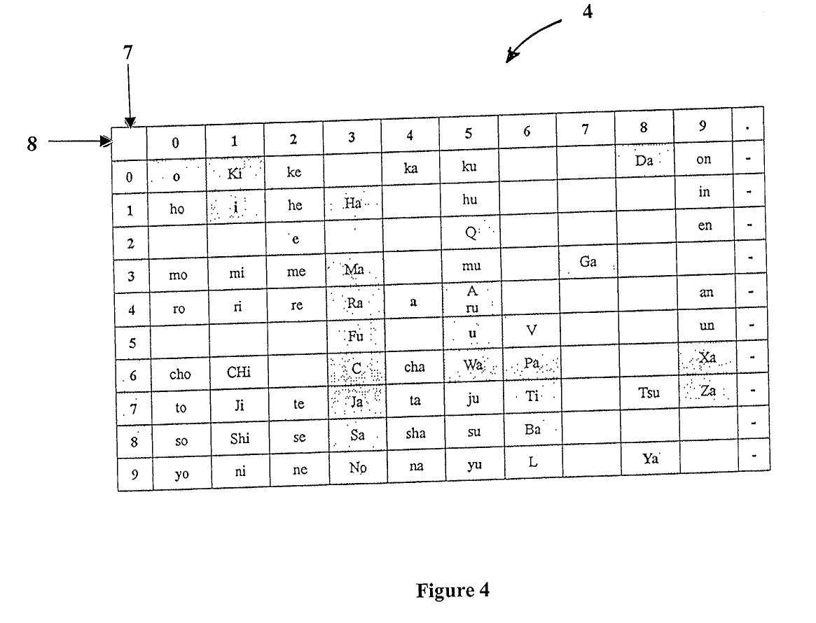

Referring to FIGS. 3 and 4, table 13 illustrates how to determine the codes for a Mandarin embodiment and table 14 illustrates how to determine codes for a Japanese language embodiment. In table 13 the shaded cells again represent the locations of the 26 letters of the alphabet in English. The non-shaded cells contain consonants and vowels in Mandarin. The consonants are in capital letters and vowels in bold lower case. Normal lower case letters represent some vowels or vowel-consonant combinations. The same scheme applies to the Japanese system in table 14.

For languages such as Chinese and Japanese, which are not built upon the Roman alphabet, the QWERTY keyboard and the ASCII character system are of little use. In order to input or display Chinese or Japanese characters on an electronic device screen specific computer software programs must be used. These software programs include font data files, an operation system, inputting method files and so on. Over 90 percent of the existing Chinese input methods are base on the user having knowledge of the structure or look of the Chinese characters to assign input key strokes. One significant advantage of this invention is that it enables Mandarin-speaking people to use their phonetic knowledge as a means to perform Chinese input tasks. This is especially important for people who have not mastered Chinese characters. The system works equally well for other languages that are not based on the Roman alphabet, such as the Japanese example shown in table 14.

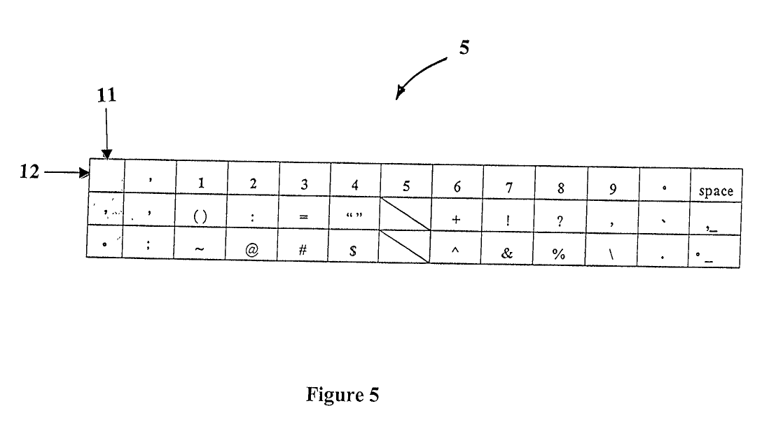

Referring again to FIG. 1, the two special character buttons 9 and 10 are used for inputting punctuation marks and other symbols. Table 15 in FIG. 5 illustrates how the codes are derived. The codes are derived by cell location as in the earlier examples. However, for special characters the user first pushes either of the two special character buttons 9 or 10 and then a number key corresponding to the desired special character. There are nine special characters printed on each of buttons 9 and 10 in a 3×3 grid. This is designed as an aid to the user to help find the second key. Take the exclamation mark (!) as an example. The exclamation mark is placed in the upper left corner of the “comma” button 9. Referring to table 15, the first key to press for inputting the sign “!” is the “comma” button 9. The second key to press is the number seven key. The number seven key is in the upper left of the center section 2 of keypad and the “!” is similarly placed on the “comma” key 9 to help the user identify that “9” is the second key to press. Similarly, the bracket mark “( )” is placed in the lower left corner of the comma button that means the first key of bracket mark is the comma button and the second key is the button “3”, the lower left corner digit button in the number keypad.

The formation and principle of the Intelligent Code Inputting Method are summed up as below. Two-digit codes are assigned to the basic characters in the applicable language, for instance the 26 letters of the English language alphabet. By using the first digit from different letters two-digit codes for letter combinations (character strings) are derived. By pressing keys which value corresponds to a two-digit code a user can input the character or character string onto the electronic device or display screen and full character input is possible without the existence of QWERTY keyboard. To save the user from the trouble of memorising the Intelligent Codes of the 26 letters of the alphabet the values of these Intelligent Codes are marked on the keypad.

The following examples illustrate how a user can input words and special characters into an electronic device.

### EXAMPLE 1

### Inputting Single Characters

Suppose a user needs to input four single characters: A B K Z. By consulting table 1 or looking at the markings printed on the number keypad the user derives that the Intelligent Codes of the characters A, B, K, and Z are 45, 85, 01 and 79 respectively. Thus to input these characters, the user should press the keys 4, 5, 8, 5, 0, 1, 7, 9 in series and the character string A, B, K, Z will be displayed on the screen.

### EXAMPLE 2

### Single Word

Suppose the user needs to input the word LIFE. From the table 6, they find the Intelligent Codes for letters L, I, F, E are 96, 11, 53 and 22 respectively. To input the word LIFE, the user should press the keys 9, 6, 1, 1, 5, 3, 2, 2 in series and the word LIFE will be displayed on the screen.

Alternatively, the user might identify that the word LIFE can be segmented into three segments which include two single characters F and E as well as a character string LI. By consulting table 1, the user knows the Intelligent Code for the string LI is 91. Therefore, the word LIFE can also be inputting by pressing keys 9, 1, 5, 3, 2, 3 in series. This requires two less keystrokes and quickens that task.

### EXAMPLE 3

### Inputting a Sentence

Suppose the user wants to input the sentence “See you.”The sentence “See you.” can be segmented into 8 single characters. They are the letter S, E, E, (space), Y, O, U, (full stop). Thus to input this sentence, the user should press the keys 8, 3, 2, 2, 2, 2 for the word SEE and a space key as well as 9, 8, 0, 0, 5, 5 for the word YOU and finally the double click of the “full stop” button 10.

To speed up the inputting process, the user can make use of the character strings “SE”, “E” and a “space” and “OU”. By then, the key pressing series will become 8, 2, 2, space, 9, 8, 0, 5 and the double click of the “full stop” button 10.

### EXAMPLE 4

### Inputting Mandarin Phonetic Character Strings

Suppose the user wants to input the Chinese word “Mandarin”. The phonetic character string for the word is PUTONGHUA.

According to table 13, the Intelligent Codes for P, U, T, ONG, H, UA are 66, 55, 76, 0, full stop, 11 and 54 respectively. Thus by pressing the button in the above order the Chinese word for Mandarin will be displayed.

### EXAMPLE 5

### Inputting Japanese Phonetic Character Strings

Suppose the user want to input the three Japanese words which mean noodle, fish and mother. The phonetic character strings for these words are UDON, SAKANA and OKA-SAN. Thus the key pressing series would be as follows:

UDON: 5, 5, 0, 8, 0, 9

SAKANA: 8, 3, 0, 1, 9, 3

OKA-SAN: 0, 0, 0, 4, full stop, 8, 3, 4, 9

Thus according to the invention there is a method of inputting characters or character strings into an electronic device without the use of a QWERTY keyboard, or the problems associated with known alternatives.

Where in the foregoing description reference has been made to integers or elements have known equivalents then such are included as if individually set forth herein.

Embodiments of the invention have been described, however it is understood that variations, improvement or modifications can take place without departure from the spirit of the invention or scope of the appended claims.

What we claim is:

1. An input system for an electronic device comprising a plurality of two digit codes representing characters or character strings wherein information is input into the electronic device by pressing combinations of keys corresponding to two digit codes on an input interface.

2. An input system as claimed in claim 1 wherein the digit codes donating the 26 letters in English are: A is 45; B is 86; C is 63; D is 08; E is 22; F is 53; G is 37; H is 13; I is 11; J. is 73; K is 01; L is 96; M is 53; N is 93; O is 00; P is 66; Q is 25; R is 43; S is 83; T is 76; U is 55; V is 56; W. is 65; X is 69; Y is 98; Z is 79.

3. An input system as claimed in claim 1 wherein the character strings are commonly used two letter combinations in the English language.

4. An input system as claimed in claim 1 wherein the character strings are letter combinations representing phonetic word sounds.

5. An input system as claimed in claim 1 further comprising a plurality of two digit codes representing punctuation marks and special characters.

6. An input system as claimed in claim 1 further comprising an input key to switch between input modes for different languages.

7. An input system for an electronic device comprising a plurality of two digit numeric codes representing characters or character strings, wherein the code for a character string comprises a combination of the first digits from its component characters, and wherein information is input into the electronic device by pressing combinations of keys corresponding to two digit codes on an input interface.

8. An input system for an electronic device comprising:
a numeric keypad, and
a plurality of two digit numeric codes representing characters or character strings wherein the code for a character string comprises a combination of the first digits from its component characters,
information being input into the electronic device by pressing combinations of numeric keys corresponding to two digit codes.

9. An input system for an electronic device comprising:
a numeric keypad including a plurality of number keys, and
a plurality of two digit numeric codes representing characters or character strings, the number key corresponding to the first digit in a two digit code for a character having printed thereon an identifier of the second digit in the code, and wherein the code for a character string comprises a commination of the first digits from its component characters.
